(19) United States
(12) Patent Application Publication
(10) Pub. No.: US 2022/0344949 A1
(43) Pub. Date: Oct. 27, 2022

(54) TRANSPOSABLE BATTERY SYSTEM

(71) Applicant: ChargeStar, Inc., Pensacola, FL (US)

(72) Inventor: John Anthony Morelli, Pensacola, FL (US)

(21) Appl. No.: 17/727,205

(22) Filed: Apr. 22, 2022

Related U.S. Application Data
(60) Provisional application No. 63/178,931, filed on Apr. 23, 2021.

(51) Int. Cl. H02J 7/00; H02J 7/06; H01M 10/42

(52) U.S. Cl. CPC H02J 7/0024; H02J 7/007; H02J 7/06; H01M 10/4207

(57) ABSTRACT

A battery charging system includes a first battery charger configured to charge a first battery, a second battery charger configured to charge a second battery, a third battery charger configured to charge a third battery, a first switch circuit configured to open and close an electrical connection between the first battery and the second battery, a second switch circuit configured to open and close an electrical connection between the second battery and the third battery, and a system controller configured to control operations of the first battery charger, the second battery charger, the third battery charger, the first switch circuit, and the second switch circuit. During a charging mode, the system controller is configured to open, by the first switch circuit, the electrical connection between the first battery and the second battery and open, by the second switch circuit, the electrical connection between the second battery and the third battery.

### PRIORITY CLAIM

This application claims priority to U.S. Provisional Patent Application No. 63/178,931, filed on Apr. 23, 2021, the entire contents of which are hereby incorporated by reference and relied upon.

### BACKGROUND

As the market for electric vehicles, power tools, laptops, and other electronic devices is booming, there has been an increased demand for batteries as an energy source for these devices. In particular, there have been more demands for high voltage batteries that need to be charged with power (e.g., 48V, 60V) higher than the power (e.g., 12V) that is typically provided by a normal/inexpensive 12V DC power supply. Special chargers may be needed to charge these high voltage batteries. For example, a 48V battery can be charged with a 48V special charger, but the 48V special charger can only charge the 48V battery and it would not work with a 36V or 60V battery. Also, conventional high voltage battery chargers may require an expensive constant voltage constant current (CVCC) device to stably charge the batteries.

### SUMMARY

The present disclosure provides new and innovative transposable battery systems. An example battery charging system includes a first battery charger configured to charge a first battery; a second battery charger configured to charge a second battery; a third battery charger configured to charge a third battery; a first switch circuit configured to open and close an electrical connection between the first battery and the second battery; a second switch circuit configured to open and close an electrical connection between the second battery and the third battery; and a system controller configured to control operations of the first battery charger, the second battery charger, the third battery charger, the first switch circuit, and the second switch circuit, wherein, during a charging mode, the system controller is configured to: open, by the first switch circuit, the electrical connection between the first battery and the second battery; and open, by the second switch circuit, the electrical connection between the second battery and the third battery.

In an aspect of the present disclosure, which may be combined with any other aspect listed herein unless specified otherwise, during a discharging mode, the system controller is configured to: close, by the first switch circuit, the electrical connection between the first battery and the second battery; and close, by the second switch circuit, the electrical connection between the second battery and the third battery.

In an aspect of the present disclosure, which may be combined with any other aspect listed herein unless specified otherwise, during a discharging mode, the system controller is configured to: open, by the first switch circuit, the electrical connection between the first battery and the second battery; and close, by the second switch circuit, the electrical connection between the second battery and the third battery.

In an aspect of the present disclosure, which may be combined with any other aspect listed herein unless specified otherwise, the battery charging system further comprises a spare battery; and a spare switch circuit configured to open and close an electrical connection between the first battery and the spare battery.

In an aspect of the present disclosure, which may be combined with any other aspect listed herein unless specified otherwise, the system controller is configured to, during the charging mode, open, by the spare switch circuit, the electrical connection between the first battery and the spare battery.

In an aspect of the present disclosure, which may be combined with any other aspect listed herein unless specified otherwise, the system controller is configured to, during a discharging mode, open, by the spare switch circuit, the electrical connection between the first battery and the spare battery.

In an aspect of the present disclosure, which may be combined with any other aspect listed herein unless specified otherwise, the system controller is configured to, during a bypass discharging mode, close, by the spare switch circuit, the electrical connection between the first battery and the spare battery.

In an aspect of the present disclosure, which may be combined with any other aspect listed herein unless specified otherwise, the battery charging system further comprises a bypass circuit configured to bypass the second battery during the bypass discharging mode by electrically connecting the first battery with the third battery without the second battery therebetween.

In an aspect of the present disclosure, which may be combined with any other aspect listed herein unless specified otherwise, during the bypass discharging mode, the system controller is configured to: open, by the first switch circuit, the electrical connection between the first battery and the second battery; and open, by the second switch circuit, the electrical connection between the second battery and the third battery.

In an aspect of the present disclosure, which may be combined with any other aspect listed herein unless specified otherwise, the first switch circuit comprises: a first transistor including a first gate, a first source configured to be connected to the second battery, and a first drain configured to be connected to the first battery, wherein the first transistor is configured to open and close the electrical connection between the first battery and the second battery depending on a first gate-source voltage formed between the first gate and the first source; and a first gate driving circuit connected to the first gate and the first source, wherein the first gate driving circuit is configured to: control the first gate-source voltage to turn-on or turn off the first transistor; and keep the first gate-source voltage equal to or lower than a predetermined voltage value.

In an aspect of the present disclosure, which may be combined with any other aspect listed herein unless specified otherwise, the predetermined voltage value is a maximum gate-source voltage of the first transistor.

In an aspect of the present disclosure, which may be combined with any other aspect listed herein unless specified otherwise, the first gate driving circuit comprises: a first Zener diode connected between the first gate and the first source; a first resistor connected between a first node and the first gate; and a first capacitor connected between the first node and the first source.

In an aspect of the present disclosure, which may be combined with any other aspect listed herein unless specified otherwise, the second switch circuit comprises: a second transistor including a second gate, a second source configured to be connected to the third battery, and a second drain configured to be connected to the second battery, wherein the second transistor is configured to open and close the electrical connection between the second battery and the third battery depending on a second gate-source voltage formed between the second gate and the second source; and a second gate driving circuit connected to the second gate and the second source, wherein the second gate driving circuit is configured to: control the second gate-source voltage to turn-on or turn off the second transistor; and keep the second gate-source voltage equal to or lower than a predetermined voltage value, wherein the second gate driving circuit comprises: a second Zener diode connected between the second gate and the second source; a second resistor connected between a second node and the second gate; and a second capacitor connected between the second node and the second source.

In an aspect of the present disclosure, which may be combined with any other aspect listed herein unless specified otherwise, each of the first, second, and third battery chargers comprises: a current sensor configured to monitor a current of a corresponding battery; and a voltage sensor configured to monitor a voltage of the corresponding battery, wherein, during the charging mode, the system controller is configured to: keep the current of the corresponding battery at a predetermined current value before the corresponding battery is fully charged; and keep the voltage of the corresponding battery at a predetermined voltage value after the corresponding battery is fully charged.

In an aspect of the present disclosure, which may be combined with any other aspect listed herein unless specified otherwise, the battery charging system further comprises a voltage multiplier configured to provide a boosted voltage to at least one of the first switch circuit and the second switch circuit.

In an aspect of the present disclosure, which may be combined with any other aspect listed herein unless specified otherwise, the boosted voltage provided to the at least one of the first switch circuit and the second switch circuit is greater than a minimum voltage that is required to turn on a transistor of the at least one of the first switch circuit and the second switch circuit.

In an aspect of the present disclosure, which may be combined with any other aspect listed herein unless specified otherwise, the minimum voltage is calculated according to the following equation: Vₘᵢₙ₋ₙ=V_{gst}+N_{B}×V_{B}, where Vₘᵢₙ₋ₙ is the minimum voltage, N_{B} is a number of series batteries between a drain of the transistor and a ground, and V_{B} is a total voltage value of each battery.

In an aspect of the present disclosure, which may be combined with any other aspect listed herein unless specified otherwise, the voltage multiplier is further configured to provide the boosted voltage to at least one of the first, second, and third battery chargers.

In an aspect of the present disclosure, which may be combined with any other aspect listed herein unless specified otherwise, the boosted voltage comprise a plurality of voltage values including a first boosted voltage and a second boosted voltage.

In an aspect of the present disclosure, which may be combined with any other aspect listed herein unless specified otherwise, the system controller is in wireless communication with a mobile device and configured to receive a command from the mobile device to limit a rate of charging/discharging at least one of the first, second, and third batteries.

In an aspect of the present disclosure, which may be combined with any other aspect listed herein unless specified otherwise, at least one of the first battery, the second battery, and the third battery comprises a plurality of battery cells connected to each other in parallel.

In an aspect of the present disclosure, which may be combined with any other aspect listed herein unless specified otherwise, a type of the first battery is different from a type of the second battery.

Another example battery charging system includes a first battery; a second battery; a third battery; a first battery charger configured to charge the first battery; a second battery charger configured to charge the second battery; a third battery charger configured to charge the third battery; a first switch circuit configured to open and close an electrical connection between the first battery and the second battery; a second switch circuit configured to open and close an electrical connection between the second battery and the third battery; and a system controller configured to control operations of the first battery charger, the second battery charger, the third battery charger, the first switch circuit, and the second switch circuit, wherein, during a charging mode, the system controller is configured to: open, by the first switch circuit, the electrical connection between the first battery and the second battery; and open, by the second switch circuit, the electrical connection between the second battery and the third battery.

Additional features and advantages of the disclosed methods and system are described in, and will be apparent from, the following Detailed Description and the Figures.

### BRIEF DESCRIPTION OF THE FIGURES

FIG. 1 is a high level block diagram of an example battery charging system according to an example of the present disclosure.

FIG. 2 is a detailed block diagram of the example battery charging system of FIG. 1 according to an example of the present disclosure.

FIG. 3 is a block diagram illustrating operations of the example battery charging system of FIGS. 1 and 2 depending on the charging/discharging/bypassing discharging mode according to an example of the present disclosure.

FIG. 4 is a block diagram illustrating the connections between a battery, a battery charger, and a switch circuit at a certain level of the example battery charging system of FIGS. 1 and 2.

FIG. 5 is a circuit diagram illustrating a switch circuit of the example battery charging system of FIGS. 1 and 2.

FIGS. 6 and 7 are circuit diagrams illustrating a voltage multiplier of the example battery charging system of FIGS. 1 and 2.

FIG. 8 is a circuit diagram illustrating an example (NMOS type) battery charger of the example battery charging system of FIGS. 1 and 2.

FIG. 9 is a circuit diagram illustrating another example (PMOS type) battery charger of the example battery charging system of FIGS. 1 and 2.

FIG. 10 is a high level block diagram of an example battery charging system according to an example of the present disclosure.

FIG. 11 is a block diagram of example battery charging systems having different discharge geometries (e.g., 20V system vs. 60V system) according to an example of the present disclosure.

FIG. 12 is a block diagram of an example of power input blocks according to an example of the present disclosure.

FIG. 13 is a block diagram of another example of power input blocks according to an example of the present disclosure.

FIG. 14 illustrates example waveforms of certain nodes in the power input blocks of FIG. 13 when the non-overlapping anti-phase clocks are synchronous.

FIG. 15 illustrates example waveforms of certain nodes in the power input blocks of FIG. 13 when the non-overlapping anti-phase clocks are asynchronous.

### DETAILED DESCRIPTION OF EXAMPLE EMBODIMENTS

Described herein are transposable battery systems. As discussed above, there have been more demands for high voltage batteries that need to be charged with power (e.g., 48V, 60V) higher than the power (e.g., 12V) that is typically provided by a normal/inexpensive 12V DC power supply, and special expensive chargers may be needed to charge these high voltage batteries. For example, a 48V special charger can only charge a 48V battery, and it would not work with a 36V or 60V battery.

Aspects of the present disclosure may provide a transposable battery system that may address the deficiencies in the conventional battery charging system. For example, in the present disclosure, during a charging mode, a battery pack may be broken down into smaller battery units so that each smaller battery unit can be charged individually (e.g., using inexpensive 12V DC power supply), which may enable faster charging for less cost. The smaller battery units may then be reassembled into the original geometry for discharging. In the present disclosure, the battery charging system may be able to bypass faulty/damaged/old battery cells and optionally swap in spare battery units to make up the loss. In this way, aspects of the present disclosure may provide a universal battery charging system that is compatible with various high voltage batteries.

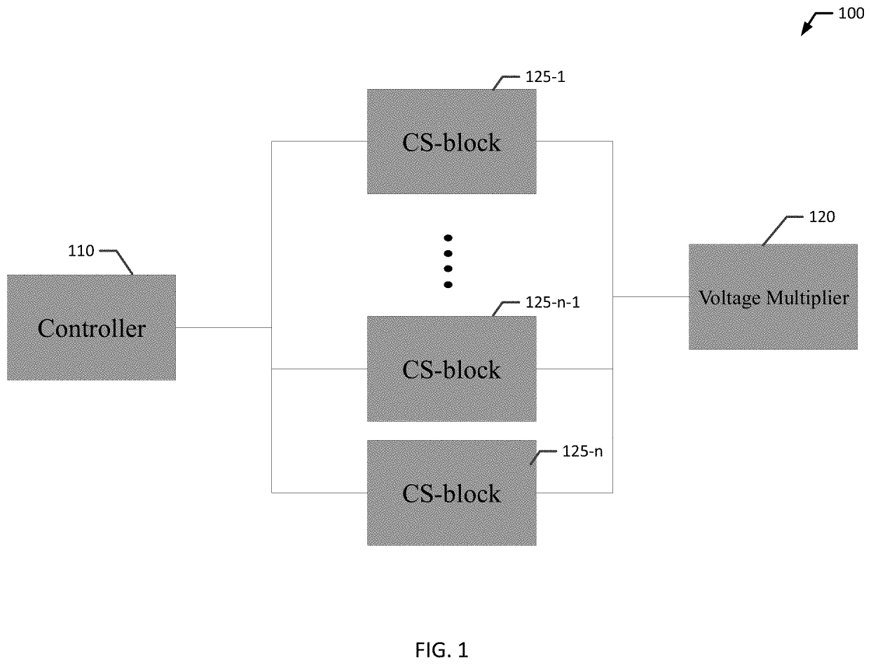

FIG. 1 depicts a high-level component diagram of an example battery charging system. In an example, the system 100 may include a system controller 110, a voltage multiplier 120, and a plurality of Charging System (CS)-blocks 125-1-125-n connected to the controller 110 and the voltage multiplier 120. The controller 110 may control operations of the CS-blocks and the voltage multiplier 120. Each of the CS-blocks may include a charger, a battery, and/or a switch circuit, which will be discussed in detail below. The controller 110 and the voltage multiplier 120 may operate by using the power/voltage from a power supply. The power supply may be a normal (DC) power supply (e.g., 12V DC power supply or 5V power from a USB port). In some examples, the battery charger may charge the battery in a wired manner as will be discussed in detail below. In other examples, the charge may charge the battery in a wireless manner.

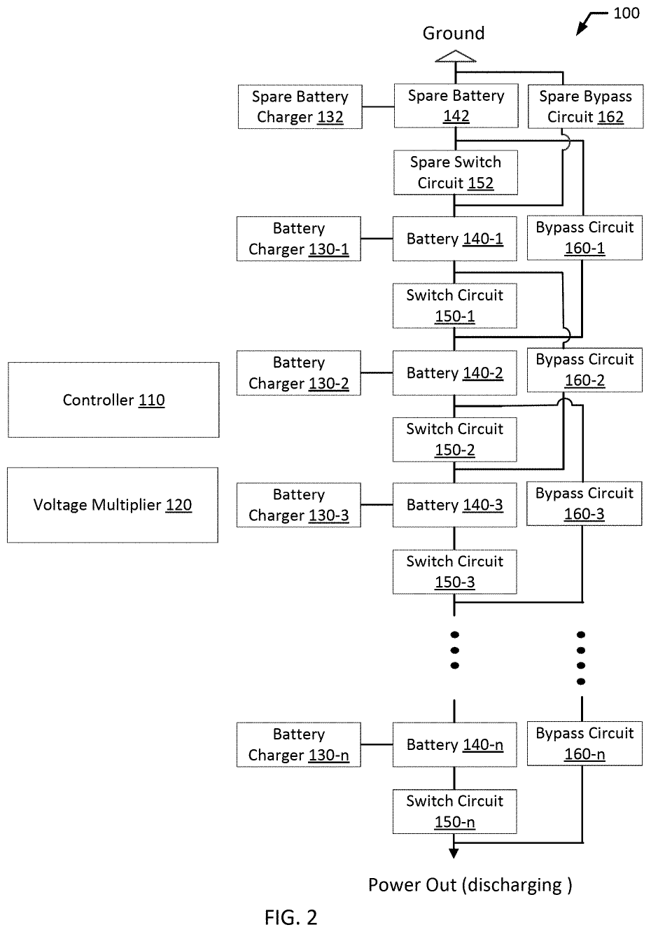

FIG. 2 depicts a detailed block diagram of the battery charging system 100 of FIG. 1 according to an example of the present disclosure. As shown in FIG. 2, the battery charging system 100 may include a plurality of battery chargers 130-1-130-n. The battery charging system 100 may further include a plurality of batteries 140-1-140-n connected to each other in series. In some examples, the number of series batteries 140-1-140-n may be in a range of 2 to 20 (e.g., 2, 3, 4, 5, 6, 7, 8, 10, 12, 13, 14, 15). In other examples, the battery charging system 100 may include any other suitable number of series batteries 140-1-140-n.

In some examples, each of the batteries 140-1-140-n may include a plurality of battery cells connected to each other in parallel. In some examples, the parallel battery cells may be welded to each other to form a single series battery unit 140-1-140-n. In some examples, the number of parallel battery cells may be in a range of 2 to 20 (e.g., 2, 3, 4, 5, 6, 7, 8, 10, 12, 13, 14, 15). In some examples, each series battery 140-1-140-n may include any other suitable number of parallel battery cells. In other examples, each series battery may include only one battery cell. In some examples, the batteries 140-1-140-n may include different types of batteries. For example, the first battery 140-1 may be a first type battery (e.g., lithium-cobalt battery), and the second battery 140-2 may be a second type battery (LiFePO4 battery) different from the first type battery. The total voltage output of the batteries 140-1-140-n may increase as more batteries are connected in series. The total capacity of the batteries 140-1-140-n may increase as more battery cells are connected in parallel in each level (i.e., each series battery 140-1-140-n).

Each of the plurality of battery chargers may be assigned to one of the plurality of batteries 140-1-140-n and configured to charge the corresponding battery assigned to the respective battery charger. For example, a first battery charger 130-1 may be configured to charge a first battery 140-1, a second battery charger 130-2 may be configured to charge a second battery 140-2, . . . and an n-th battery charger 130-n may be configured to charge an n-th battery 140-n. In some examples, the first battery 140-1 may be electrically connected to a ground.

The battery charging system 100 may further include a plurality of switch circuits 150-1-150-n. Each of the switch circuits 150-1-150-n may be disposed between the batteries 140-1-140-n and configured to open and close an electrical connection between the adjacent batteries. For example, a first switch circuit 150-1 may be disposed between the first battery 140-1 and the second battery 140-2 and configured to open and close an electrical connection between the first battery 140-1 and the second battery 140-2. A second switch circuit 150-1 may be disposed between the second battery 140-2 and the third battery 140-3 and configured to open and close an electrical connection between the second battery 140-2 and the third battery 140-3. An n-th switch circuit 150-1 may be disposed between the n-th battery 140-n and the power out node and configured to open and close an electrical connection between the n-th battery 140-n and the power out node.

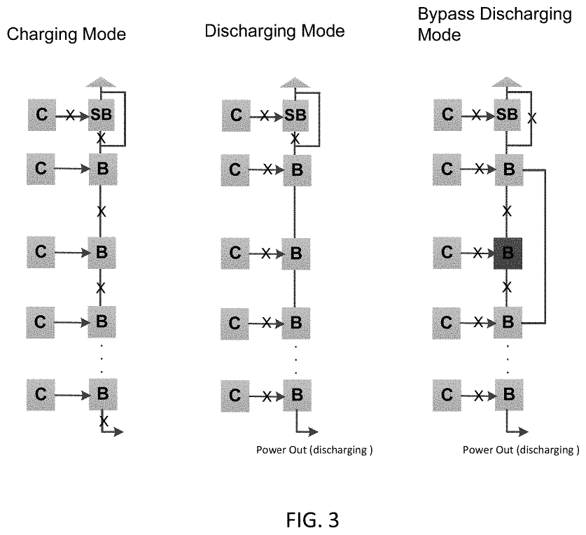

As discussed above, the system controller 110 may be configured to control operations of the battery chargers 130-1-130-n and switch circuits 150-1-150-n. For example, as shown in FIG. 3, during a charging mode, the system controller may be configured to open, by the switch circuits, the electrical connections between the series batteries 140-1-140-n. In this way, during the charging mode, the series batteries 140-1-140-n are divided into a single battery unit (B) so that each single battery unit (B) can be charged by each battery charger 130-1-130-n assigned thereto.

As shown in FIG. 3, during a discharging mode, the system controller 110 may be configured to close, by the switch circuits, the electrical connections between the series batteries 140-1-140-n. In an example, during the discharging mode, the system controller may operate the battery chargers 130-1-130-n so that the batteries 140-1-140-n are not charging during the discharging mode (e.g., disconnecting the charger from the battery using a switch, or simply not charging).

In some examples, during the discharging mode, the system controller 110 may be able to change the total voltage output value of the system by disconnecting some of the batteries. For example, if there are 15 series batteries in the system and each series battery outputs 4V, a total output voltage value of the 15 series batteries would be 60V. However, when it is desired that the battery system outputs a different total voltage value (e.g., 48V instead of 60V), during the discharging mode, the system controller 110 may remove one or more series batteries, for example, by opening one or more switch circuits. For example, in order to change the output voltage from 60V to 48V, the system controller may disconnect three batteries (e.g., batteries 140-1-140-3), by opening one or more switch circuits (e.g., third switch circuit 150-3) while closing the other switch circuits (e.g., switch circuits 150-4-150-15). In this case, the control system would make sure that the battery (e.g., battery 140-4) in an end opposite to the power output node is connected to the ground, for example, by configuring a separate switch that can selectively connect each of the battery directly to the ground, when necessary.

In some examples, as illustrated in FIG. 2, the battery charging system 100 may further include a spare battery 142, a spare battery charger 132, a spare switch circuit 152, a spare bypass circuit 162, and/or bypass circuits 160-1-160-n. The spare battery charger 132 may be configured to charge the spare battery 142. In some examples, the spare battery charger 132 may be configured to charge the spare battery 142. In some examples, there may be multiple spare batteries, multiple spare battery chargers, multiple spare switch circuits, and multiple spare bypass circuits.

In some examples, the spare switch circuit 152 may be disposed between the spare battery 142 and the first battery 140-1 and configured to open and close an electrical connection between the first battery 140-1 and the spare battery 142. In other examples, the spare switch circuit 152 may be disposed between the spare battery 142 and any other suitable battery (e.g., battery 140-n) and configured to open and close an electrical connection between the spare battery 142 and the adjacent battery (e.g., battery 140-n).

Each of the bypass circuits 160-1-160-n may be assigned to each battery and configured to bypass each corresponding battery 140-1-140-n, for example, when there is an issue in the corresponding battery. For example, a bypass circuit may bypass a corresponding battery during a bypass discharging mode by electrically connecting the batteries adjacent the corresponding battery without the corresponding battery therebetween. In some examples, the bypass circuits 160-1-160-n may comprise a switch (e.g., MOSFET switch or any other suitable switches).

Examples of the issue may include a battery that is faulty, damaged, and/or old, which may be not charging/discharging or may be slow in charging/discharging. As a default, the bypass circuits 160-1-160-n may be in an open position all the time, and the bypass circuit 160-1-160-n may be closed when necessary (e.g., when it needs to bypass the corresponding battery with issues). For example, when a second battery 140-2 has an issue, as illustrated in FIG. 3, the system 100 may operate in the bypass discharging mode, and the controller 110 may close the second bypass circuit 160-2 to bypass the second battery 140-2.

During the bypass discharging mode, the system controller 110 may also close, by the spare switch circuit 152, the electrical connection between the spare battery 142 and the adjacent battery (e.g., first battery 140-1). In this way, the system of the present disclosure may advantageously be able to replace the faulty/damaged/old battery with a normal spare battery, by simply controlling the bypass circuit and the spare switch circuit.

In some examples, one or more bypass circuits may be closed to reconfigure the total output voltage (e.g., from 60V to 48V). For example, in the 15 batteries example above (total 60V output voltage), in order to change the output voltage from 60V to 48V, the system controller may bypass three batteries (e.g., batteries 140-4, 140-8, 140-12), by closing three bypass switches (e.g., bypass switches 160-4, 160-8, 160-12) and opening switch circuits adjacent the three bypassed batteries (e.g., switch circuits 150-3, 150-5, 150-7, 150-9, 150-11, and 150-13).

As illustrated in FIG. 3, the system controller 110 may be configured to, during the charging mode and/or the (normal) discharging mode, open, by the spare switch circuit 152, the electrical connection between the spare battery 142 and the adjacent battery (e.g., first battery 140-1). In some examples, as a default, the spare bypass circuit may be in a close position all the time to bypass the spare battery. When the system 100 needs to use the spare battery 142, the controller 110 may open the spare bypass circuit 162. In some examples, the spare bypass circuit 162 may comprise a switch (e.g., MOSFET switch or any other suitable switches).

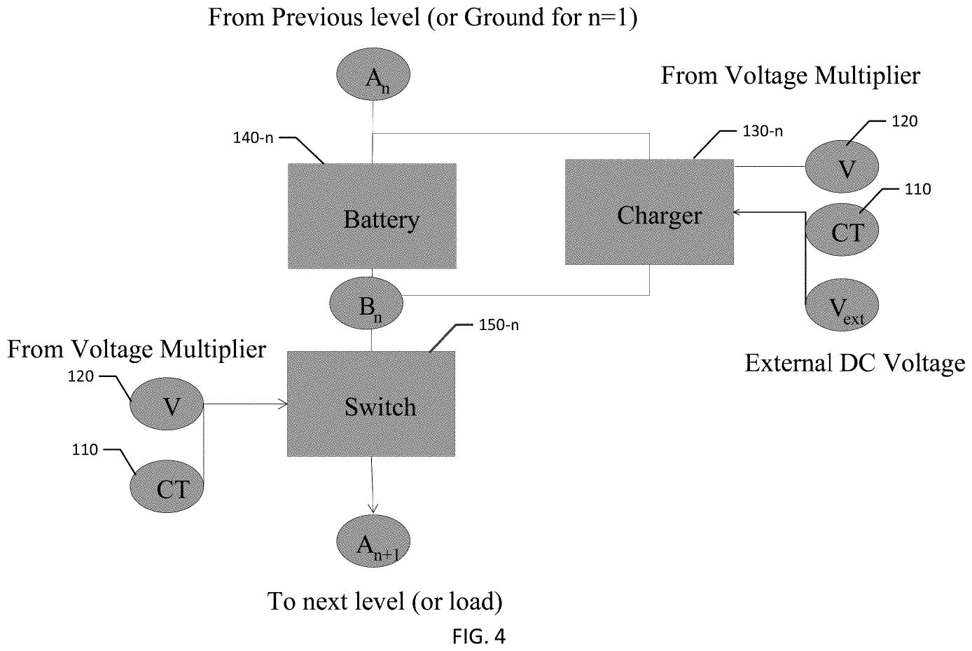

FIG. 4 illustrates the connections between the components (a battery, a battery charger, and a switch circuit) in a CS block at a given level (e.g., CS block 125-n) according to an example of the present disclosure. As shown in FIG. 4, the battery 140-n may be disposed between Aₙ node and Bₙ node, and the charger 130-n corresponding to the battery 140-n is connected to the Aₙ and Bₙ nodes. The switch 150-n may be disposed between Bₙ node and Aₙ₊₁ node. Aₙ₊₁ node may be connected to the battery in the next level. Aₙ node may be ground when n is 1. The charger 130-n may receive input signals/voltages from the controller 110, the voltage multiplier 120, and/or an external power supply (Vext). The external power supply may be a normal (DC) power supply (e.g., 12V DC power supply). The switch 150-n may receive input signals/voltages from the controller 110 and the voltage multiplier 120.

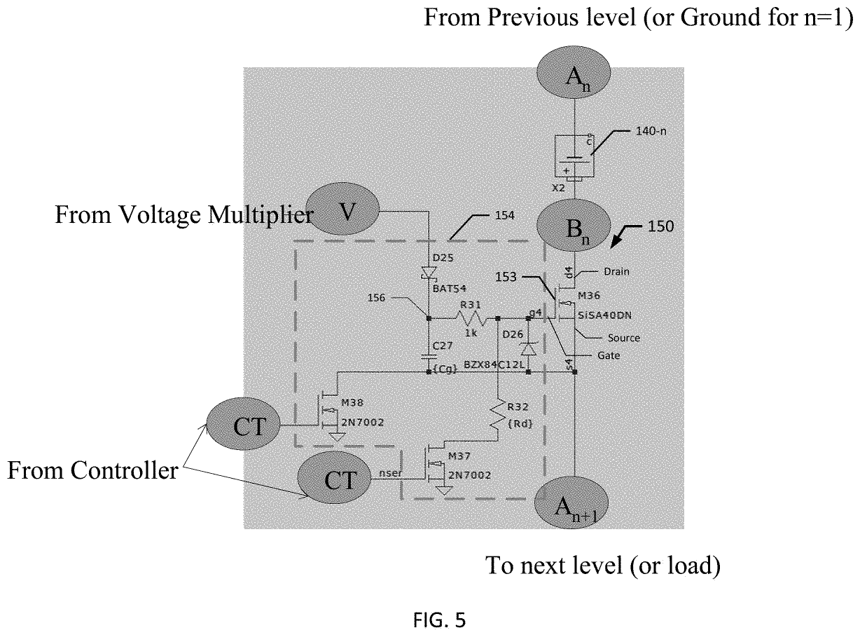

FIG. 5 is a circuit diagram illustrating a switch circuit 150-1-150-n according to an example of the present disclosure. As illustrated in FIG. 5, the switch circuit 150-1-150-n may include a transistor 153 and a gate driving circuit 154. The transistor 153 may include a gate, a source configured to be connected to Aₙ₊₁ node (and ultimately the battery in the next level), and a drain configured to be connected to Bₙ node (and the battery 140-n). The transistor 153 may be configured to open and close the electrical connection between Bₙ node (and the battery 140-n) and Aₙ₊₁ node (and the battery in the next level or the power output node) depending on the gate-source voltage V_{gs} formed between the gate and the source. In some examples, the transistor 153 may be a MOSFET transistor (e.g., NMOS). In order to close/turn on the transistor 153 (e.g., fully close the transistor 153) so as to close the electrical connection between Bₙ node and Aₙ₊₁ node, the gate-source voltage V_{gs} may need to be equal to or greater than a predetermined voltage value V_{gst} (e.g., 12V).

The gate driving circuit 154 may be connected to the gate and the source of the transistor 153. The gate driving circuit 154 may be configured to control the gate-source voltage V_{gs} to turn-on/off the transistor 153 and keep the gate-source voltage V_{gs} equal to or lower than a predetermined voltage value (e.g., 12V). In some examples, the predetermined voltage value may be equal to or lower than a maximum gate-source voltage of the transistor 153.

The gate driving circuit 154 may include a Zener diode (e.g., D26 in FIG. 5) connected between the gate and the source, a resistor (e.g., R31 in FIG. 5) connected between a first node 156 and the gate, and a capacitor (e.g., C27 in FIG. 5) connected between the first node 156 and the source. As illustrated in FIG. 5, a high voltage input (V) from the voltage multiplier 120 may flow down to the first node 156. The voltage input (V) from the voltage multiplier 120 may be higher than the voltage that is required to turn on the transistor 153. For example, if a set voltage (e.g., 16V) is needed to turn on the transistor 153, the voltage input (V) from the voltage multiplier 120 may be any voltage equal to or greater than the set voltage (16V). The high input voltage from the voltage multiplier 120 may be clamped by the Zener diode (D26) to keep the gate-source voltage V_{gs} equal to or lower than the predetermined voltage value (e.g., 12V), which may be equal to or lower than the maximum gate-source voltage of the transistor 153.

For example, the Zener diode may start to conduct only when the voltage across the Zener diode is greater than a threshold Zener voltage (e.g., 12V). In some examples, the threshold Zener voltage of the Zener diode may be the same as the predetermined voltage value V_{gst} (e.g., 12V). If the voltage across the Zener diode, which is equal to the gate-source voltage V_{gs} in FIG. 5, is less than the threshold voltage (e.g., 12V), the Zener diode may not conduct. When the voltage across the Zener diode (i.e., V_{gs}) is equal to or greater than the threshold Zener voltage, the Zener diode may shut the current away from the gate of the transistor 153 so that the gate-source voltage V_{gs} would not exceed the threshold Zener voltage. In this way, the Zener diode may keep the gate-source voltage V_{gs} equal to or lower than the threshold Zener voltage/the predetermined voltage value V_{gst}.

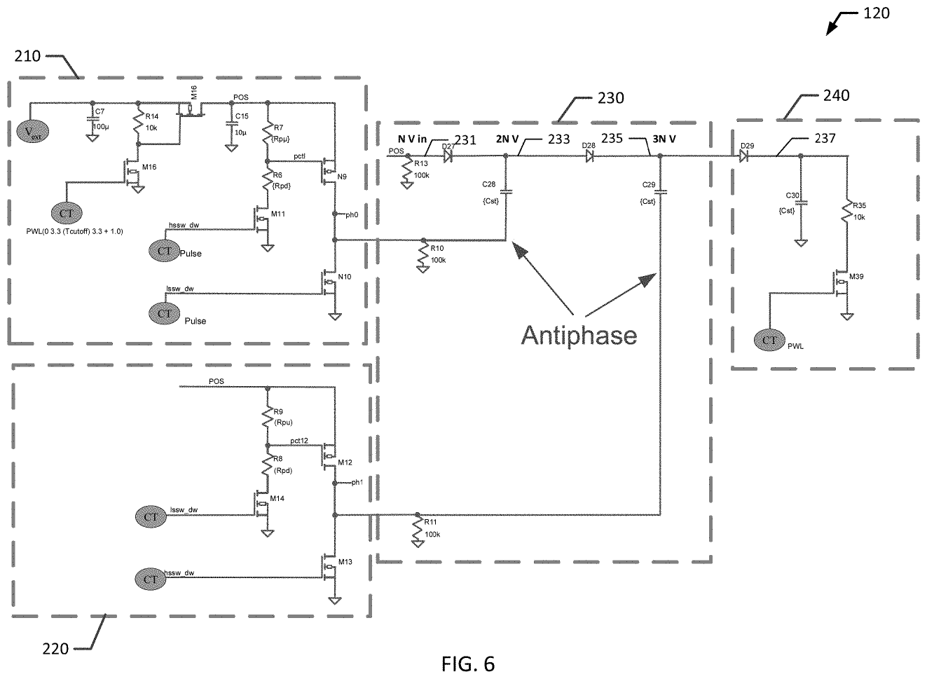

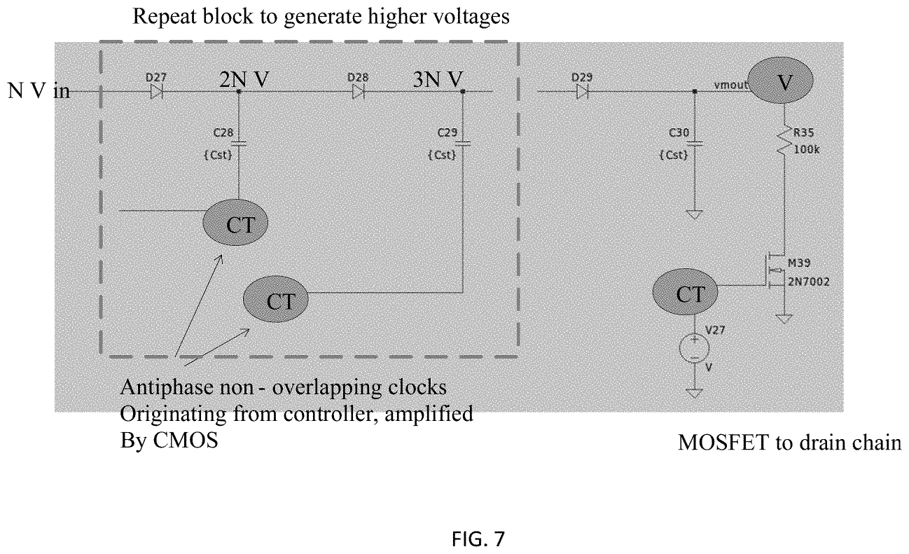

FIGS. 6 and 7 are circuit diagrams illustrating a voltage multiplier 120 according to an example of the present disclosure. The voltage multiplier 120 may be configured to provide a boosted voltage to the switch circuits 150-1-150-n and/or the battery chargers 130-1-130-n. The boosted voltage may include a plurality of voltage values/outputs. In some examples, the voltage multiplier 120 may provide the plurality of voltage values/outputs by multiplying a voltage input from an external power source (e.g., DC power source). For example, when NV DC voltage is provided from an external power source, the voltage multiplier 120 may generate voltage values/outputs that are an integer multiple of the NV DC voltage (e.g., 2N V, 3N V, 4N V, 5N V, . . . ).

As illustrated in FIG. 6, the voltage multiplier 120 may include four circuit parts: a phase 0 part 210, a phase 1 part 220, a multiplier part 230, and a drain part 240. The phase 0 part 210 and the phase 1 part 220 may produce square waves that are opposite to each other in phase (e.g., one is high and the other is low). In some examples, there might be a brief dead time (both phases are low) to prevent a situation where both phases are in a high status. As shown in FIGS. 6 and 7, these antiphase non-overlapping clocks may be originated from the controller (CT) 110, amplified by the transistors (e.g., CMOS transistors) in the phase 0 part 210 and the phase 1 part 220, and delivered to the capacitors (i.e., C28 and C29).

Based on the square waves from the phase 0 part 210 and the phase 1 part 220, the multiplier part 230 may multiply the input voltage from an external power source. For example, if N V (e.g., 12V) is input at node 231, 2N V (e.g., 24V) may be generated at node 233, and 3N V (e.g., 36V) may be generated at node 235. Ph0 node of the phase 0 part 210 and ph1 node of the phase 1 part 220, which output the square waves discussed above, may be connected to nodes 233 and 235, respectively. A diode (D29) may be provided to smooth the output voltage (3N V) generated at node 235 and, thus, node 237 may have the same voltage value (e.g., 3N V) as node 235. The drain part 240 may be provided to drain the voltage generated in the voltage multiplier 120, for example, when the voltage multiplier 120 is powered off (e.g., by turning on the transistor (M39) by the controller 120).

As illustrated in FIG. 7, in some examples, the multiply part 230 (and associated parts 210 and 220) may be repeated to generate higher voltages. For example, node 231 of a second multiply part may be connected to node 235 of the first multiply part 230, and this would allow the second multiply part to generate 4N (e.g., 48V) at node 233 of the second multiply part and 5N (e.g., 60V) at node 235 of the second multiply part, which may be connected to node 237 of the drain part 240.

In order to change the operation mode from the charging mode to the discharging mode, for example, after each of the batteries 140-1-140-n are fully charged, the switch circuits 150-1-150-n may need to be closed, which may require the transistor 153 of the switch circuits 150-1-150-n to be turned on. As discussed above, in order to turn on the transistor 153 (e.g., fully turning on) of the switch circuits 150-1-150-n, the gate-source voltage V_{gs} of the transistor 153 may need to be equal to or greater than a predetermined voltage value V_{gst} (e.g., 12V). Referring back to FIGS. 2 and 5, the drain of the transistor 153 at a given level (e.g., nth level) may be connected to a battery in the same level (battery 140-n), and there might be additional batteries connected between the battery 140-n and the ground. Therefore, to turn on the transistor 153 at a given level, the voltage multiplier 120 may need to provide a voltage value that is greater than a sum of the predetermined voltage value V_{gst} (e.g., 12V) and the total voltage values of the series batteries between the drain node (e.g., Bₙ) of the transistor 153 and the ground. This can be expressed as in the following equation:

Vₘᵢₙ₋ₙ=V_{gst}+N_{B}×V_{B} (Equation 1)

Vₘᵢₙ₋ₙ is the minimum voltage that is needed from the voltage multiplier 120 to turn on the transistor 153 of the switch circuit 150-n at a given level n, V_{gst} is the predetermined gate-source voltage that is required to turn on the transistor 153, N_{B} is the number of series batteries between the drain node (e.g., Bₙ) of the transistor 153 and the ground, and V_{B} is the total voltage value of each series battery (e.g., when fully charged). Therefore, the switch circuits 150-1-150-n may receive different voltage values from the voltage multiplier 120 depending on the level in which each switch circuit is located in the stack of the series batteries 140-1-140-n. For example, in some examples, the controller 110 may control the switch circuit 150-1-150-n to be connected to a node (e.g., node 231, 233, 235, or 237) of the voltage multiplier 120 that may provide a voltage value that is equal to/greater than and closest to Vₘᵢₙ₋ₙ among the boost voltage generated in the voltage multiplier 120 (e.g., 1N V, 2N V, 3N V, 4N V, 5N V).

As an example, when it is assumed that the voltage multiplier 120 generates voltage values that are an integer multiple of 12V (e.g., 12V, 24V, 36V, 48V, 60V, 72V, etc.), V_{gst} is 12V, n (total number of series batteries in the system) is 15, and V_{B} is 4V, Vₘᵢₙ₋ₙ and the voltage V from the voltage multiplier 120 to each switch circuit at a given level may have values in the below table:

| | | | V (voltage from the voltage |
|---|---|---|---|
| | N_{B} × V_{B} | Vₘᵢₙ₋ₙ | multiplier 120 to switch circuit |
| Level | (Volt) | (Volt) | at the given level) (Volt) |
| 1 (e.g., switch | 4 | 16 | 24 |
| circuit 150-1) | | | |
| 2 (e.g., switch | 8 | 20 | 24 |
| circuit 150-2) | | | |
| 3 (e.g., switch | 12 | 24 | 24 |
| circuit 150-3) | | | |
| 4 (e.g., switch | 16 | 28 | 36 |
| circuit 150-4) | | | |
| 5 (e.g., switch | 20 | 32 | 36 |
| circuit 150-5) | | | |
| 6 (e.g., switch | 24 | 36 | 36 |
| circuit 150-6) | | | |
| 7 (e.g., switch | 28 | 40 | 48 |
| circuit 150-7) | | | |
| 8 (e.g., switch | 32 | 44 | 48 |
| circuit 150-8) | | | |
| 9 (e.g., switch | 36 | 48 | 48 |
| circuit 150-9) | | | |
| 10 (e.g., switch | 40 | 52 | 60 |
| circuit 150-10) | | | |
| 11 (e.g., switch | 44 | 56 | 60 |
| circuit 150-11) | | | |
| 12 (e.g., switch | 48 | 60 | 60 |
| circuit 150-12) | | | |
| 13 (e.g., switch | 52 | 64 | 72 |
| circuit 150-13) | | | |
| 14 (e.g., switch | 56 | 68 | 72 |
| circuit 150-14) | | | |
| 15 (e.g., switch | 60 | 72 | 72 |
| circuit 150-15) | | | |

In other examples, the controller 110 may control the switch circuit 150-1-150-n to be connected to a node (e.g., node 231, 233, 235, or 237) of the voltage multiplier 120 that may provide any voltage value that is generated in the voltage multiplier 120 as long as it is equal to/greater than the Vₘᵢₙ₋ₙ.

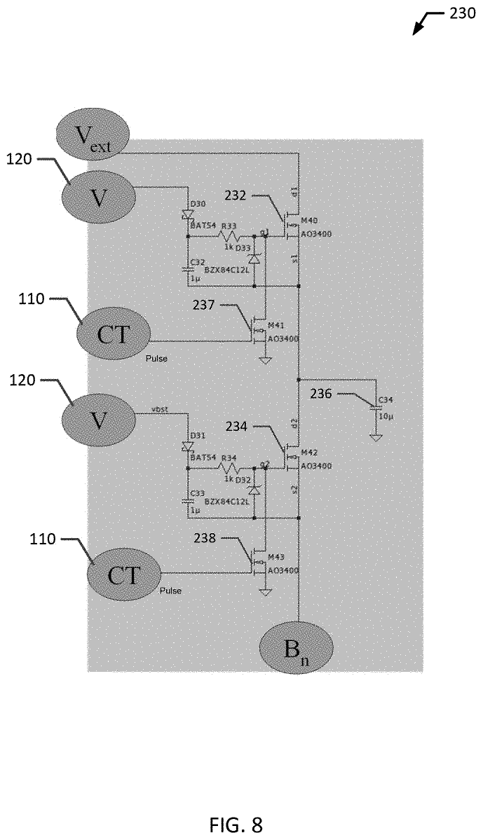

FIG. 8 is a circuit diagram illustrating an example (NMOS type) battery charger 230 (e.g., battery chargers 130-1-130-n) according to an example of the present disclosure. The battery charger 230 may use NMOS type transistors. As illustrated in FIG. 8, an external power source Vext (e.g., 12V DC power) may be connected to the NMOS type battery charger 230 to provide power to Bₙ node (and ultimately to the battery), and power from the voltage multiplier 120 may be also provided to turn on the transistors 232 and 234. The amount of power that is delivered to Bₙ node may be determined based on the frequency of the switching of the transistors 232 and 234, which are connected to the external voltage source. For example, the frequency of the switching of the transistors 232 and 234 may determine how much current flows into Bₙ node (and the battery).

The transistors 232 and 234 may be driven in antiphase (one transistor is on and the other transistor is off), which may allow a packet of electricity to charge up the capacitor 236. Then, when the transistor 232 is off and the transistor 234 is on, the capacitor 236 may transmit the charged energy to the battery (node Bₙ). The controller (CT) 110 may control the transistors 232 and 234 (and ultimately the frequency) by providing pulse signals (e.g., 3V pulses) to the transistors 237 and 238.

In some examples, the system controller 110 may control the battery charger 230 to operate like a CVCC device. For example, in some examples, the system controller 110 may control the battery charger 230 to have a 50% duty cycle as a default setting during the charging mode, but the duty cycle can be changed. By adjusting the frequency of the pulses coming out of the external voltage source during the charging mode, the system controller 110 may keep the current of the corresponding battery at a predetermined current value before the corresponding battery is fully charged and keep the voltage of the corresponding battery at a predetermined voltage value after the corresponding battery is fully charged. In this way, aspects of the present disclosure may be able to operate the battery charger 230 to follow the CVCC charging profile without using an expensive CVCC device.

In some examples, the battery charger 230 may include a feedback loop (e.g., current sensor and/or voltage sensor) to monitor the current and voltage of the battery. For example, in some examples, a sensor resistor may be provided underneath the battery and a voltage across of the sensor resistor may be measured to determine the current flowing into the battery. The controller 110 may include a first analog to digital controller part that may read the voltage across the sensor resistor. The controller 110 may further include a second analog to digital controller part that may read the voltage provided to the battery to make sure that the battery is not overvolting. Based on the sensed current and voltage of the battery, the controller 110 may adjust the frequency/duty cycle.

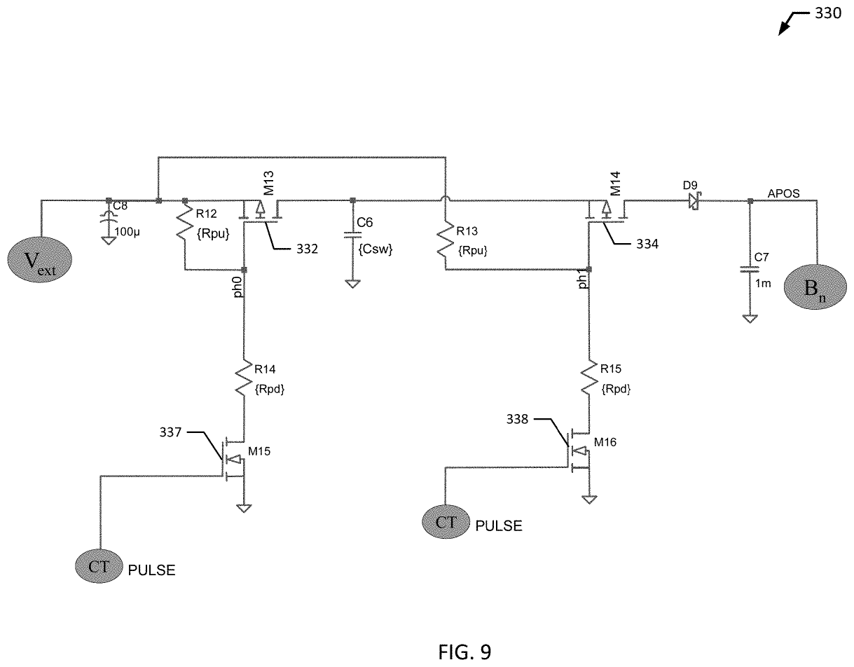

FIG. 9 is a circuit diagram illustrating an example (PMOS type) battery charger 330 (e.g., battery chargers 130-1-130-n) according to an example of the present disclosure. The battery charger 330 may use PMOS type transistors. As illustrated in FIG. 9, an external power source Vext (e.g., 12V DC power) may be connected to the PMOS type battery charger 330 to provide power to Bₙ node (and ultimately to the battery). Since, in PMOS transistors, negative gate-source voltage is applied to turn on the transistors, the battery charger 330 may not need the high voltage power from the voltage multiplier 120.

The amount of power that is delivered to Bₙ node may be determined based on the frequency of the switching of the transistors 332 and 334, which are connected to the external voltage source (Vext). The frequency of the switching of the transistors 332 and 334 may determine how much current flows into Bₙ node (and the battery). Other features/operations/characteristics of the battery charger 330 may be similar to the ones of the battery charger 230 (e.g., adjustment of the frequency and duty cycle using the transistors 332, 334, 337, AND 338, CVCC charging profile, feedback loop, etc.), except that the battery charger 330 uses PMOS transistors instead of NMOS transistors, and thus, duplicate descriptions may be omitted.

In some (alternative) examples, the battery charger(s) of the battery charging system 100 may not have a one-to-one match with the batteries for each level. In some examples, the battery charging system 100 may include only one battery charger that may be connected to the batteries in each level one by one (e.g., in succession), for example, via a switch circuit (e.g., standard MOSFET switch circuit with the Zener-Vgs control driven by the voltage multiplier as discussed above with respect to the switch circuits).

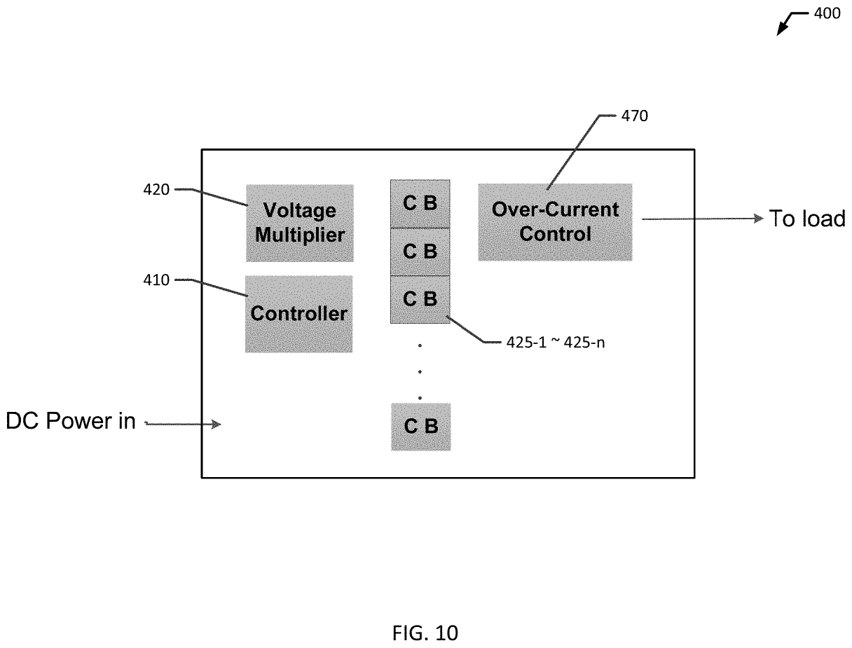

FIG. 10 is a high level block diagram of an example battery charging system 300 according to an example of the present disclosure. The features/operations/characteristics of the battery charging system 400 (e.g., controller 410, voltage multiplier 420, CB blocks 425-1-125-n, etc.) may be similar to and/or same as the ones described for the battery charging system 100 (e.g., controller 110, voltage multiplier 120, CB blocks 125-1-125-n, battery chargers, switch circuits, batteries, etc.) and, thus, duplicate descriptions may be omitted.

As illustrated in FIG. 10, the battery charging system 400 may further include an over current control device 470. The over current control device 470 may be disposed between a load and the series batteries and prevent over-discharging. In some examples, the over current control device 470 may be a thermistor. In other examples, the over current control device 470 may be any other suitable device that can prevent over-discharging (e.g., MOSFET transistor that shuts off when an overcurrent is detected).

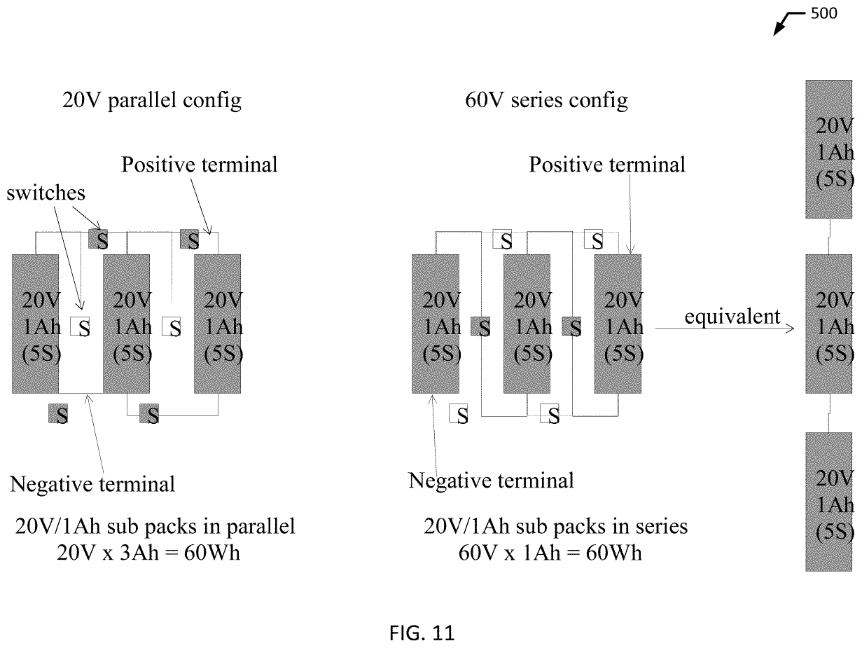

FIG. 11 illustrates a block diagram 500 of example battery charging systems having different discharge geometries (e.g., 20V system vs. 60V system) according to an example of the present disclosure. As shown in FIG. 11, aspects of the present disclosure may allow for different discharge geometries (e.g., reassembling a set of cells from 20V system to 60V system, or vice versa). For example, a series of three 20V/1 A batteries (each having five 4V battery cells in series) having a total 60V output (60 Wh) may be reconfigured to three 20V/1 A batteries (each having five 4V battery cells in series) in parallel having a total 20V output (60 Wh) with higher current capacity and/or longer life. In some examples, using the above-discussed battery charging systems with different discharge geometries, a battery pack can be used to charge various power tools with different voltage outputs (e.g., 20V power tool and 60V power tool).

As another example, in the present disclosure, a series of five batteries (each with three battery cells at 4V in parallel) having a total 20V output (5×3 geometry) may be reconfigured to a series of three batteries (each with five battery cells in parallel) having a total 12V output (3×5 geometry), which may have higher current capacity and/or longer life.

In some examples, the battery charger(s) of the battery charging system 100 may be separate from the power tools and/or batteries (e.g., the battery chargers and/or switch circuits being part of a cord or a stand). In some examples, the batteries may be detached from the power tools in order to charge the batteries using the battery charger(s) of the battery charging system 100. In other examples, the battery charging system 100 of the present disclosure (battery chargers, batteries, and switch circuits, etc.) may be built into a product (e.g., electric vehicle, power tools, laptops, and other electronic devices).

In some examples, the system controller 100 may be in wireless communication with a mobile device. Examples of the wireless communication may include Bluetooth, Wi-Fi, ZigBee, GPS, Wi-Max, LTE, CDMA, or any other wireless communication protocols. The system controller 100 may be configured to receive a command from the mobile device to limit a rate of charging/discharging the batteries 140-1-140-n. The mobile device may include a mobile application for controlling the system controller 100. In this case, the mobile application may provide a graphic user interface (GUI). The GUI may include a slider that may allow a user to change the rate of charging/discharging. Using the GUI, a user may be able to set the maximum charging current. When the maximum charging current is lowered, the batteries may be charged slowly, which may enhance the battery life. The user may be able to increase the maximum charging current to charge the battery quickly.

In some examples, the system controller 100 may be configured to receive a command from the mobile device to lock the batteries/battery chargers in an inoperable state, which may deter a possible theft attempt. The battery charging systems of the present disclosure can be used for a smart phone, a laptop computer, an electrical vehicle, power tools, or any other electronic device requiring high voltage batteries/chargers.

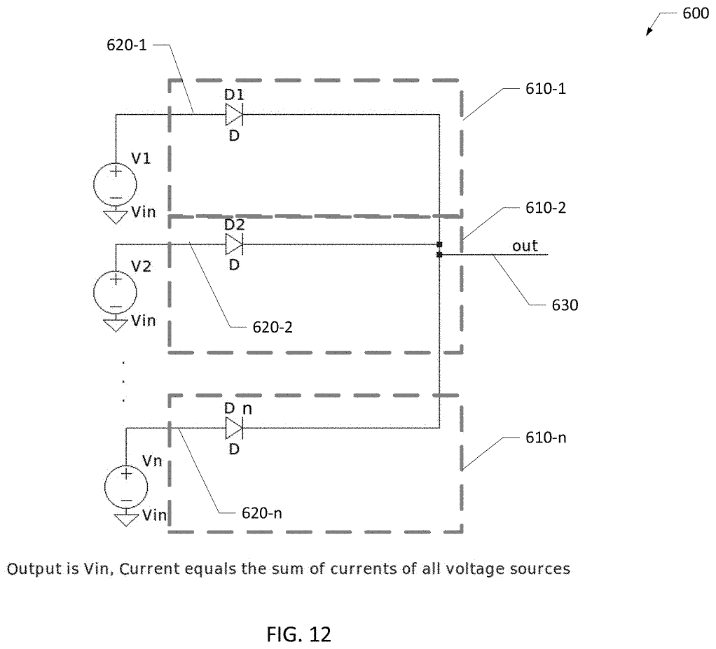

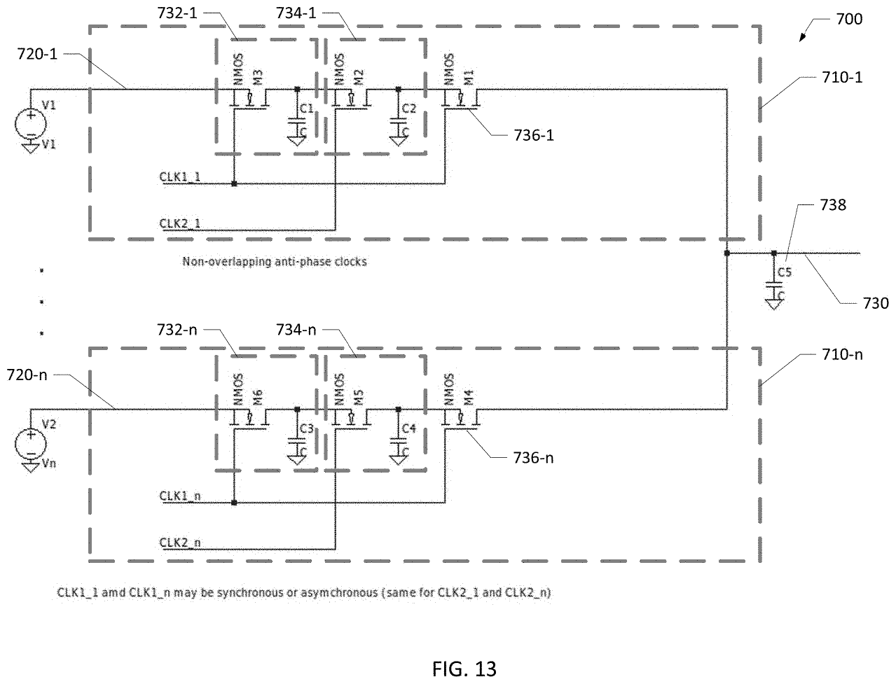

Referring to FIGS. 12 and 13, in some examples, the system 100 may further include a plurality of power input blocks. The plurality of power input blocks can be used simultaneously to charge the battery faster. In some examples, the external power supply/source (Vext) (e.g., in the charger 130-n/230) may include the plurality of power input blocks

FIG. 12 illustrates an example of a plurality of power input blocks 610-1-610-n according to an example of the present disclosure. The plurality of power input blocks 610-1-610-n may be connected to each other in parallel. Each of the power input blocks 610-1-610-n may include an input portion 620-1-620-n, a diode D1-Dn, and an output node 630. In some examples, power (e.g., 100 Watts) may be supplied to the input portion 620-1-620-n from an electrical power grid (e.g., through the power outlet on the wall). The output node 630 may provide a total external power supply/source (Vext).

In some examples, the input portion 620-1-620-n may include or connected to a USB-C charger cable. The USB-C charger cable may have a USB-C input in one end, and a DC output in another end. In other examples, the input portion 620-1-620-n may include or connected to any other suitable charger cable.

The diode D1-Dn in each of the power input blocks 610-1-610-n may prevent the supplied power back-flowing from one to another. The didoes may have a negative temperature coefficient. The diode D1-Dn in each of the power input blocks 610-1-610-n may be coupled to each other. For example, all of the diodes D1-Dn of the power input blocks 610-1-610-n may be thermally coupled to each other through a thermal coupling material (e.g., metal) so that each of the diodes D1-Dn maintains the substantially same temperature as each other. Examples of the thermal coupling material may include aluminum or any other suitable thermally conductive material (e.g., light weight thermally conductive metal).

Although there are three power input blocks shown in FIG. 12, there can be more or less than three power input blocks (e.g., 2, 4, 5, 6, 7, . . . ). The more power input blocks are provided, the faster the battery can be charged. For example, when there are three power input blocks provided, the charging speed may be three times faster (than when there is a single power input block). The charging speed may be proportional to the number of the power input blocks.

In some examples, when the power input blocks are located inside the system 100, the system 100 may include a separate port for each of the input portion 620-1-620-n. In other examples, the power input blocks may be external to the system 100. In that case, the system 100 may include a port (e.g., single port) for receiving the power (e.g., total Vext) from the output node 630.

FIG. 13 illustrates another example of a plurality of power input blocks 710-1-710-n according to an example of the present disclosure. The plurality of power input blocks 710-1-710-n may be connected to each other in parallel. Each of the power input blocks 710-1-710-n may include an input portion 720-1-720-n, an output node 730, and a circuit portion between the input portion 720-1-720-n and the output node 730.

The circuit portion may include a first stage circuit 732-1-732-n and a second stage circuit 734-1-734-n. The first stage circuit 732-1-732-n may be connected to the input portion 720-1-720-n. The first stage circuit 732-1-732-n may include a first transistor (e.g., MOSFET M3, M6) and a first capacitor connected to each other in series. A source of the first transistor may be connected to the input portion 720-1-720-n.

The second stage circuit 734-1-734-n may be connected to the first stage circuit 732-1-732-n in series. The second stage circuit 734-1-734-n may include a second transistor (e.g., MOSFET M2, M5) and a second capacitor connected to each other in series. A source of the second transistor may be connected to a node between the first stage circuit 732-1-732-n and the second stage circuit 734-1-734-n.

In some examples, the circuit portion may further include a third transistor 736-1-736-n connected to the second stage circuit 734-1-734-n. In some examples, a third capacitor 738 may be connected to the third transistors 736-1-736-n. In some examples, the third transistor 736-1-736-n and the third capacitor 738 may be connected to the output node 730.

In some examples, the first and second transistors in the first stage circuit 732-1-732-n and the second stage circuit 734-1-734-n may operate in an antiphase manner. For example, the gate of the first transistor may receive a first clock signal CLK1_1-CLK1_n, and the gate of the second transistor may receive a second clock signal CLK2_1-CLK2_n. The first clock signal CLK1_1-CLK1_n and the second clock signal CLK2_1-CLK2_n may be in antiphase so that when the first transistor is in an on state, the second transistor is in an off state, and when the second transistor is in an on state, the first transistor is in an off state. In some examples, the gate of the third transistor 736-1-736-n may receive the same clock signal (e.g., first clock signal CLK1_1-CLK1_n) as the gate of the first transistor.

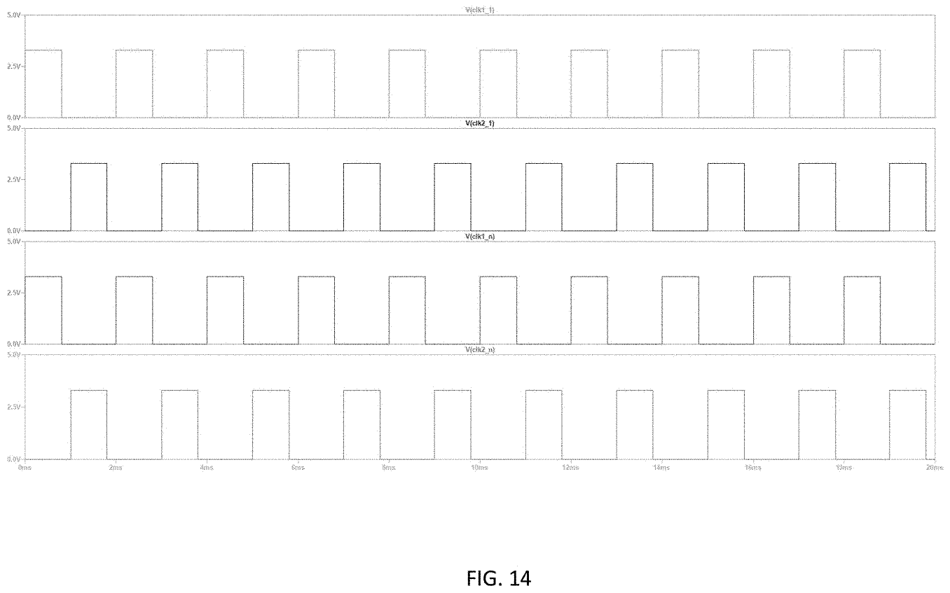

FIG. 14 illustrates example waveforms of certain nodes in the power input blocks of FIG. 13 when the non-overlapping anti-phase clocks are synchronous. As shown in FIG. 14, in some examples, the first clock signals CLK1_1-CLK1_n (and the second clock signals CLK2_1-CLK2_n similarly) may be synchronous (e.g., all the edges of the first clock signals CLK1_1-CLK1_n are aligned or have a constant phase relationship). That is, in this case, the phase relation between sets of clocks may be zero.

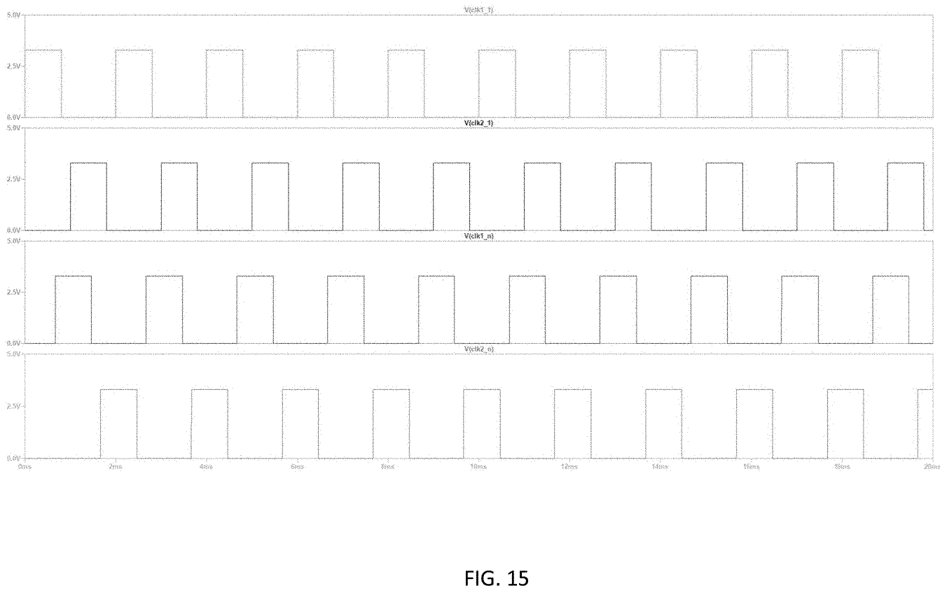

FIG. 15 illustrates example waveforms of certain nodes in the power input blocks of FIG. 13 when the non-overlapping anti-phase clocks are asynchronous. As shown in FIG. 15, in other examples, the first clock signals CLK1_1-CLK1_n (and the second clock signals CLK2_1-CLK2_n similarly) may be asynchronous (e.g., the edges of the first clock signals CLK1_1-CLK1_n are not aligned or do not have a constant phase relationship). When the clock signals are asynchronous, there does not need to be a locking mechanism to keep sets of clocks aligned.

In some examples, power (e.g., 100 Watts) may be supplied to the input portion 720-1-720-n from an electrical power grid (e.g., through the power outlet on the wall). The output node 730 may provide a total external power supply/source (Vext).

In some examples, the input portion 720-1-720-n may include or connected to a USB-C charger cable. The USB-C charger cable may have a USB-C input in one end, and a DC output in another end. In other examples, the input portion 720-1-720-n may include or connected to any other suitable charger cable.

The transistors of the power input blocks 710-1-710-n may have a positive temperature coefficient. Therefore, the transistors of the power input blocks 710-1-710-n may not need to be thermally coupled to each other.

Although there are two power input blocks shown in FIG. 13, there can be more than two power input blocks (e.g., 3, 4, 5, 6, 7, . . . ). The more power input blocks 710-1-710-n are provided, the faster the battery can be charged. The charging speed may be proportional to the number of the power input blocks 710-1-710-n.

In some examples, when the power input blocks are located inside the system 100, the system 100 may include a separate port for each of the input portion 720-1-720-n. In other examples, the power input blocks may be external to the system 100. In that case, the system 100 may include a port (e.g., a single port) for receiving the power from the output node 730.

In the present disclosure, the terms “including” and “comprising” are used in an open-ended fashion, and thus should be interpreted to mean “including, but not limited to . . . .” As used herein, the terms “about,” “approximately,” “substantially,” “generally,” and the like mean plus or minus 10% of the stated value or range.

In some examples, the battery charging system of the present disclosure may include and/or be operated using a computing device. As used herein, the term “computing device” may refer to any suitable device (or collection of devices) that is configured to execute, store, and/or generate machine readable instructions (e.g., non-transitory machine readable medium). A computing device may include a processor and a memory, wherein the processor is to execute machine readable instructions that are stored on the memory.

Reference throughout the specification to “various aspects,” “some aspects,” “some examples,” “other examples,” or “one aspect” means that a particular feature, structure, or characteristic described in connection with the aspect is included in at least one example. Thus, appearances of the phrases “in various aspects,” “in some aspects,” “certain embodiments,” “some examples,” “other examples,” “certain other embodiments,” or “in one aspect” in places throughout the specification are not necessarily all referring to the same aspect. Furthermore, the particular features, structures, or characteristics illustrated or described in connection with one example may be combined, in whole or in part, with features, structures, or characteristics of one or more other aspects without limitation.

It is to be understood that at least some of the figures and descriptions herein have been simplified to illustrate elements that are relevant for a clear understanding of the disclosure while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements may not be provided herein.

The terminology used herein is intended to describe particular embodiments only and is not intended to be limiting of the present disclosure. As used herein, the singular forms “a,” “an,” and “the” are intended to include the plural forms as well, unless otherwise indicated. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term ‘at least one of X or Y’ or ‘at least one of X and Y’ should be interpreted as X, or Y, or X and Y.

It should be understood that various changes and modifications to the examples described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A battery charging system comprising:
a first battery charger configured to charge a first battery;
a second battery charger configured to charge a second battery;
a third battery charger configured to charge a third battery;
a first switch circuit configured to open and close an electrical connection between the first battery and the second battery;
a second switch circuit configured to open and close an electrical connection between the second battery and the third battery; and
a system controller configured to control operations of the first battery charger, the second battery charger, the third battery charger, the first switch circuit, and the second switch circuit,
wherein, during a charging mode, the system controller is configured to:
open, by the first switch circuit, the electrical connection between the first battery and the second battery; and
open, by the second switch circuit, the electrical connection between the second battery and the third battery.

2. The battery charging system of claim 1, wherein, during a discharging mode, the system controller is configured to:
close, by the first switch circuit, the electrical connection between the first battery and the second battery; and
close, by the second switch circuit, the electrical connection between the second battery and the third battery.

3. The battery charging system of claim 1, wherein, during a discharging mode, the system controller is configured to:
open, by the first switch circuit, the electrical connection between the first battery and the second battery; and
close, by the second switch circuit, the electrical connection between the second battery and the third battery.

4. The battery charging system of claim 1, further comprising;
a spare battery; and
a spare switch circuit configured to open and close an electrical connection between the first battery and the spare battery.

5. The battery charging system of claim 4, wherein the system controller is configured to, during the charging mode, open, by the spare switch circuit, the electrical connection between the first battery and the spare battery.

6. The battery charging system of claim 4, wherein the system controller is configured to, during a discharging mode, open, by the spare switch circuit, the electrical connection between the first battery and the spare battery.

7. The battery charging system of claim 4, wherein the system controller is configured to, during a bypass discharging mode, close, by the spare switch circuit, the electrical connection between the first battery and the spare battery.

8. The battery charging system of claim 7, further comprising a bypass circuit configured to bypass the second battery during the bypass discharging mode by electrically connecting the first battery with the third battery without the second battery therebetween.

9. The battery charging system of claim 8, wherein, during the bypass discharging mode, the system controller is configured to:
open, by the first switch circuit, the electrical connection between the first battery and the second battery; and
open, by the second switch circuit, the electrical connection between the second battery and the third battery.

10. The battery charging system of claim 1, wherein the first switch circuit comprises:
a first transistor including a first gate, a first source configured to be connected to the second battery, and a first drain configured to be connected to the first battery, wherein the first transistor is configured to open and close the electrical connection between the first battery and the second battery depending on a first gate-source voltage formed between the first gate and the first source; and
a first gate driving circuit connected to the first gate and the first source, wherein the first gate driving circuit is configured to:
control the first gate-source voltage to turn-on or turn off the first transistor; and
keep the first gate-source voltage equal to or lower than a predetermined voltage value.

11. The battery charging system of claim 10, wherein the predetermined voltage value is a maximum gate-source voltage of the first transistor.

12. The battery charging system of claim 10, wherein the first gate driving circuit comprises:
a first Zener diode connected between the first gate and the first source;
a first resistor connected between a first node and the first gate; and
a first capacitor connected between the first node and the first source.

13. The battery charging system of claim 1, wherein each of the first, second, and third battery chargers comprises:
a current sensor configured to monitor a current of a corresponding battery; and
a voltage sensor configured to monitor a voltage of the corresponding battery,
wherein, during the charging mode, the system controller is configured to:
keep the current of the corresponding battery at a predetermined current value before the corresponding battery is fully charged; and
keep the voltage of the corresponding battery at a predetermined voltage value after the corresponding battery is fully charged.

14. The battery charging system of claim 1, further comprising a voltage multiplier configured to provide a boosted voltage to at least one of the first switch circuit and the second switch circuit.

15. The battery charging system of claim 14, wherein the boosted voltage provided to the at least one of the first switch circuit and the second switch circuit is greater than a minimum voltage that is required to turn on a transistor of the at least one of the first switch circuit and the second switch circuit.

16. The battery charging system of claim 15, wherein the minimum voltage is calculated according to the following equation:
Vₘᵢₙ₋ₙ=V_{gst}+N_{B}×V_{B},
where Vₘᵢₙ₋ₙ is the minimum voltage, N_{B} is a number of series batteries between a drain of the transistor and a ground, and V_{B} is a total voltage value of each battery.

17. The battery charging system of claim 14, wherein the voltage multiplier is further configured to provide the boosted voltage to at least one of the first, second, and third battery chargers.

18. The battery charging system of claim 14, wherein the boosted voltage comprise a plurality of voltage values including a first boosted voltage and a second boosted voltage.

19. The battery charging system of claim 1, wherein at least one of the first battery, the second battery, and the third battery comprises a plurality of battery cells connected to each other in parallel.

20. A battery pack system comprising:
a first battery;
a second battery;
a third battery;
a first battery charger configured to charge the first battery;
a second battery charger configured to charge the second battery;
a third battery charger configured to charge the third battery;
a first switch circuit configured to open and close an electrical connection between the first battery and the second battery;
a second switch circuit configured to open and close an electrical connection between the second battery and the third battery; and
a system controller configured to control operations of the first battery charger, the second battery charger, the third battery charger, the first switch circuit, and the second switch circuit,
wherein, during a charging mode, the system controller is configured to:
open, by the first switch circuit, the electrical connection between the first battery and the second battery; and
open, by the second switch circuit, the electrical connection between the second battery and the third battery.
